(19) United States
(12) Patent Application Publication
(10) Pub. No.: US 2007/0149253 A1
(43) Pub. Date: Jun. 28, 2007

(54) External megaphone system of the mobile phone

(75) Inventors: Kuo-Chih Lee, Taipei (TW); Chun-Cheng Wu, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/319,300

(22) Filed: Dec. 27, 2005

(51) Int. Cl. H04B 1/38; H04M 1/00

(52) U.S. Cl. 455/569.1; 455/567

(57) ABSTRACT

An external megaphone system of the mobile phone for broadcasting an incoming call sound signal of the mobile phone is provided. The mobile phone has a body with a sound interface and a built-in megaphone provided therein. When the external megaphone device is inserted into the sound output hole (not the earphone output) of the mobile phone by a user, an incoming call ringtone signal of a sound interface is output to the external megaphone device and the built-in megaphone. Also, the sound output hole of external megaphone system of the mobile phone is further provided with a mechanical switch or an electronic switch as so to control the communication between the sound interface and the external megaphone device to output the incoming call ringtone signal of the sound interface.

### BACKGROUND OF THE INVENTION

1. Field of Invention

The present invention relates to an external megaphone system of the mobile phone, and more particularly, to a megaphone system having an optimal function of amplifying the ring tone so that the user is less likely to miss the incoming call.

2. Related Art

Nowadays, due to the fast development of the communication industry, the original two-party communication mode of the wired telephone or the intercom has been changed to a mode of mobile handheld wireless communication, which is implemented by the instrument referred to as a mobile phone or cell phone, so as to enable the users to communicate with others at anytime.

With reference to FIG. 1, many outdoor users do not like to hold their mobile phone 1 in hand all the time for the sake of comfort, and often put it in their pockets or handbags. However, this may cause the sound wave of an incoming call ring tone isolated in the pockets or handbags and prevent it from going outside. That is, the sound interface of the mobile phone cannot transmit the ring tone by a built-in megaphone to the outside, which may cause the user less likely to notice the ring tone, especially in a noisy environment, and therefore the user may miss an important and time-critical call. As a result, many outdoor users have to take notice of whether a ring tone exists or not all the time.

Furthermore, in order to avoid missing the important and time-critical calls because of the likeliness to be unconscious of a ring tone as mentioned above, many users hang the mobile phone in front by a cord to avoid missing calls. However, hanging the mobile phone in front by such a cord may lead to uncomfortableness, and the mobile phone would strike the user's breast when the mobile phone user is walking or doing activities, so it is not a rather recommended way of informing the user of the calls by hanging the mobile phone in front. Also, most mobile phone fittings currently available in the market are megaphone devices about earphone and handfree answering, and are unable to inform the user of an incoming call to prevent missing calls.

As known from the above description, there is no conventional and preferable means for informing the user of an incoming call when the mobile phone user is outside. Therefore, it's an object of the practitioners to develop a new megaphone system of the mobile phone, which informs the user outside of an incoming call to prevent missing calls and can be used with other cell phone fittings to enhance benefit.

### SUMMARY OF THE INVENTION

In view of the problems of the conventional technology described above, the present invention provides an external megaphone system of the mobile phone for solving a conventional problem that a user may be less likely to notice the ring tone and therefore miss calls outdoors as the ring tone of the mobile phone is transmitted through a built-in megaphone.

To achieve the above object, the present invention provides an external megaphone system of the mobile phone, comprising a mobile phone and an external megaphone device. Furthermore, the mobile phone further comprises a body, with a sound output hole (rather than the conventional earphone output) provided on a surface of the body. In addition, a sound interface and a built-in megaphone are provided within the body of the mobile phone. When the external megaphone device of the external megaphone system of the mobile phone is inserted into the sound output hole of the mobile phone, the ring tone signal of the sound interface is output to the external megaphone device and the built-in megaphone. The sound output hole is provided with a mechanical switch or an electronic switch, so that when the external megaphone device is not connected with the mobile phone, the ring tone of the incoming call is output by the built-in megaphone; and when the external megaphone device is connected to the sound output hole of the mobile phone, the circuit between the sound interface and the external megaphone device is switched on by the mechanical switch or the electronic switch while the circuit between the sound interface and the built-in megaphone is switched off. When the mobile phone receives an incoming call ring tone signal, the external megaphone device outputs the ring tone to inform the user of the incoming call.

To achieve the above object, the detailed content and embodied implementation of the present invention will be illustrated with reference to the following drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional mobile phone with a built-in megaphone;

FIG. 2A is a schematic view of a mobile phone broadcasting the ring tone by a built-in megaphone;

FIG. 2B is a schematic view of a mobile phone broadcasting the ring tone by a built-in megaphone and an external megaphone device;

FIG. 3 is a block diagram of a mechanical switch circuitry of the present invention;

FIG. 4A is a schematic view of a mobile phone with a switch controlling the built-in megaphone to broadcast the ring tone;

FIG. 4B is a schematic view of a mobile phone with a switch controlling the external megaphone device to broadcast the ring tone; and

FIG. 5 is a block diagram of an electronic switch circuitry of the present invention.

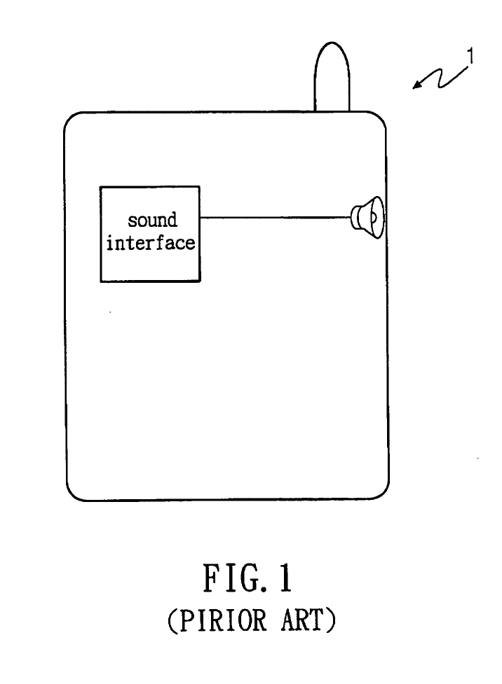

### DETAILED DESCRIPTION OF THE INVENTION

Hereinafter, the assembly and the implementation of the preferred embodiments of the present invention are described in detail with reference to the accompanying drawings.

The present invention relates to an external megaphone system of the mobile phone for broadcasting the sound signal of an incoming call of the mobile phone. When the external megaphone device of the external megaphone system of the mobile phone is inserted into the sound output hole (not the earphone output) of the mobile phone, the incoming call ring tone signal of the sound interface is output thereby to the external megaphone device and the built-in megaphone. Otherwise, the mobile phone using the external megaphone system of the present invention further comprises a switch at the sound output hole to switch on the circuit between the sound interface and the external megaphone device, so as to output the incoming call ring tone signal of the sound interface by the external megaphone device. Consequently, when the user does not want to hold it in hand for the sake of comfortableness, the user may put the mobile phone in the pocket or handbag with the external megaphone device exposed outside, so that the user can be easily informed of an incoming call even in a noisy environment and will not miss important or time-critical calls.

The present invention provides an external megaphone system of the mobile phone and a preferred embodiment of connecting the external megaphone device of the system to the mobile phone, and discloses the implementation of the implementing features used for sending the incoming call ring tone signals of the mobile phone.

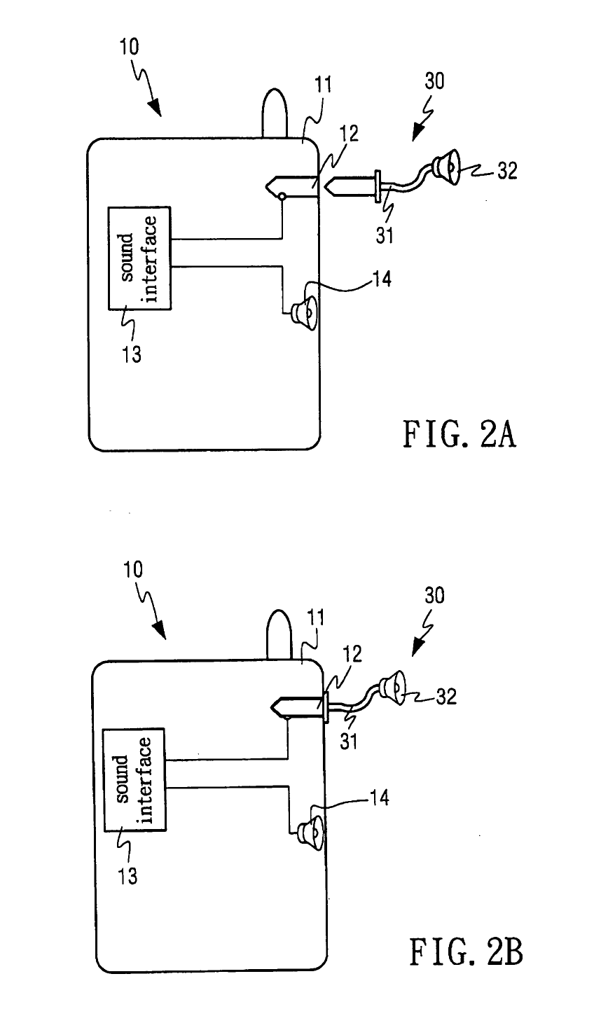

Referring to FIGS. 2A and 2B, the present invention provides an external megaphone system of the mobile phone, comprising a mobile phone 10 and an external megaphone device 30. Furthermore, the mobile phone 10 comprises a body 11 with a sound output hole 12 provided on a surface of the body 11, and a sound interface 13 and a built-in megaphone 14 connected to the sound interface 13 provided within the body 11 of the mobile phone 10, wherein the mobile phone 10 may further comprise a conventional earphone jack (not shown, but not to be limited), the sound interface 13 is used to extract an incoming call signal to the built-in megaphone 14 and an external megaphone device 30. In addition, the external megaphone device 30 comprises a sound signal line 31 and a megaphone 32, that is, the megaphone 32 is connected with a sound signal line 31. When the external megaphone device 30 is connected with the mobile phone 10, that is, the external megaphone device 30 is connected to the sound output hole 12 of the mobile phone 10 by a sound signal line 31, the external megaphone device 30 is communicated with the circuit contact of the sound interface 13 by the sound signal line 31. When the mobile phone receives an incoming call ring tone signal, as the sound interface 13 is connected with the built-in megaphone 14 and the external megaphone device 30, the sound interface 13 outputs the extracted call signal to the built-in megaphone 14 and the external megaphone device 30, and then the built-in megaphone 14 and the megaphone 32 of the external megaphone device 30 output the incoming call ring tone, that is, broadcast the ring tone to inform the user of the incoming call, to make sure that the user knows every incoming call.

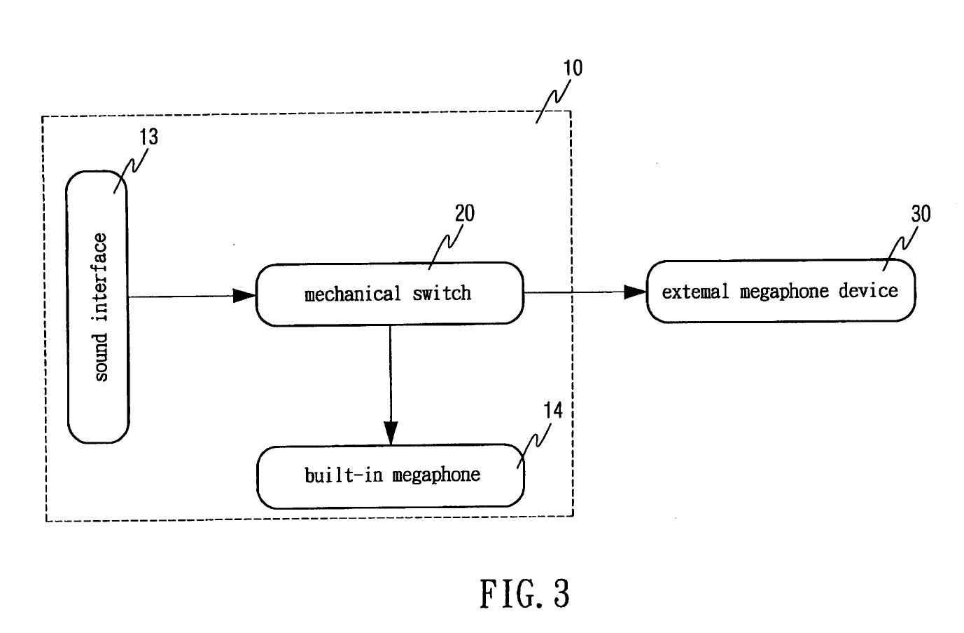

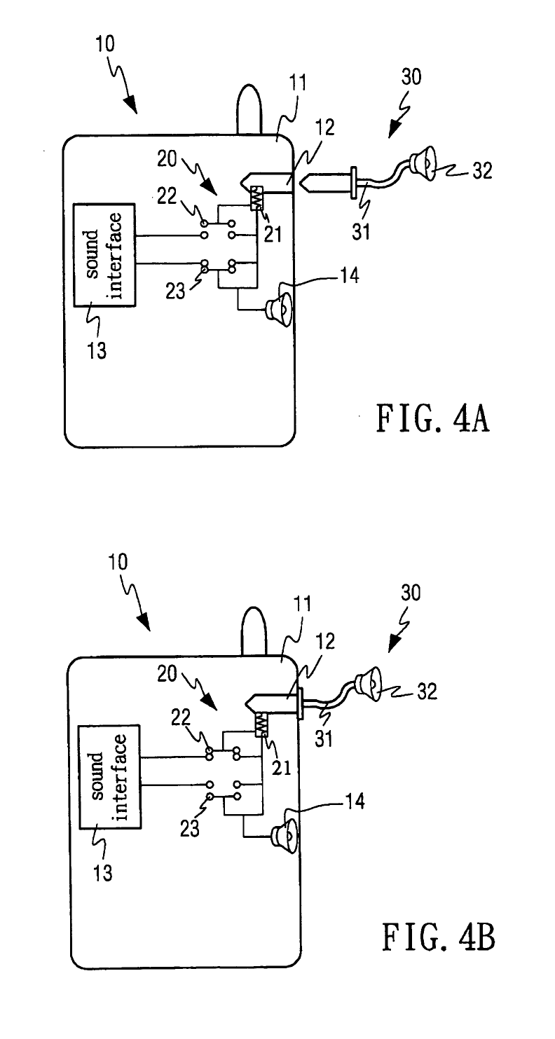

Furthermore, referring to FIGS. 3 and 4A, an external megaphone system of the mobile phone of the present invention, to save the power consumption of the mobile phone, may further provided a switch at the sound output hole 12 within the body 11 of the mobile phone 10 to output the ring tone only by the built-in megaphone 14 or the external megaphone device 30. The switch described above may be for example, but not limited to a mechanical switch 20. Of course, the switch may also achieve the purpose of switching the sound signal by using other conventional switches. The mechanical switch 20 described above comprises an elastomer 21, a first switch 22 and a second switch 23. The elastomer 21 is for example a spring with an elastic force and connected to the first switch 22 and the second switch 23. And more specifically, when the elastomer 21 of the mechanical switch 20 is in a predetermined state without being compressed, the sound interface 13 is connected with the built-in megaphone 14, and the second switch 23 switches on the circuit between the sound interface 13 and the built-in megaphone 14; similarly, when the sound interface 13 is connected with the external megaphone device 30, the first switch 22 switches on the circuit between the sound interface 13 and the external megaphone device 30, and the second switch 23 switches off the circuit between the sound interface 13 and the built-in megaphone 14.

Referring to FIG. 4A, when the external megaphone device 30 is not connected with the mobile phone 10, that is, the external megaphone device 30 is not connected to the sound output hole 12 of the mobile phone 10 by a sound signal line 31, the sound signal line 31 is not compressed to the elastomer 21 of the mechanical switch 20, that is, the second switch 23 switches on the circuit between the sound interface 13 and the built-in megaphone 14. When the mobile phone 10 receives an incoming call ring tone signal, as the sound interface 13 is connected with the built-in megaphone 14, the extracted incoming call signal is output to the built-in megaphone 14 by the sound interface 13, and then the built-in megaphone 14 of the mobile phone 10 outputs the ring tone, that is, broadcasts the ring tone to inform the user. And referring to FIG. 4B, when the external megaphone device 30 is connected to the mobile phone 10, that is, the external megaphone device 30 is connected to the sound output hole 12 of the mobile phone 10 by a sound signal line 31, as the sound signal line 31 is compressed to the elastomer 21 of the mechanical switch 20, the elastomer 21 moves downwards, driving the first switch 22 and the second switch 23. That is, the first switch 22 switches on the circuit between the sound interface 13 and the external megaphone device 30, and the second switch 23 switches off the circuit between the sound interface 13 and the built-in megaphone 14. Thus, when the mobile phone 10 receives an incoming call ring tone signal, as the sound interface 13 is connected to the external megaphone device 30, the extracted incoming call signal is output to the external megaphone device 30 by the sound interface 13, and then the megaphone 32 of the external megaphone device 30 outputs the incoming call ring tone, that is, broadcasts the ring tone to inform the user so as to make sure that the user knows every incoming call.

The present invention provides an external megaphone system of the mobile phone. The mechanical switch 20 of the external megaphone system described above is used to switch the output of the ring tone signal to be broadcast by the external megaphone device 30 or the built-in megaphone 14 of the mobile phone 10. Furthermore, an elastomer 21 disclosed in the preferred embodiments described above is, for example but not limited to, a spring with a control switch using the elastic force for switching. The mechanical switch 20 of the present invention may achieve the purpose of switching of the control switch by using other means such as a spring or a compressor.

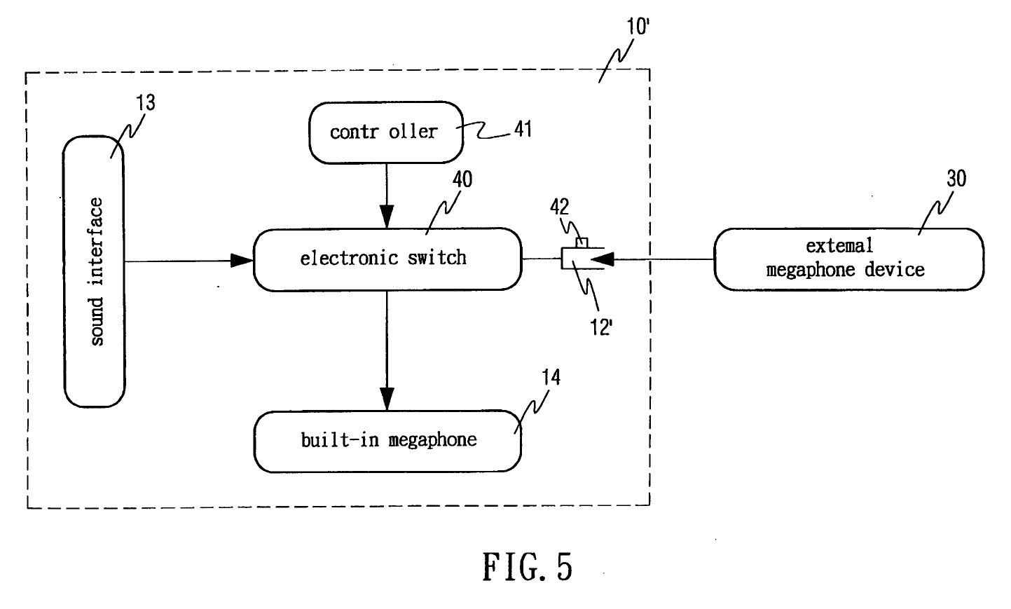

Additionally, in an external megaphone system 10′ of the mobile phone of the present invention, the switch described above may also be an electronic switch 40, as shown in FIG. 5. When the sound interface 13 is connected with the built-in megaphone 14, or the sound interface 13 is connected with the external megaphone device 30 by the sound output hole 12′, the connection signal between the two is sensed by a sensor 42, and then the electronic switch 40 switches on the communication between the sound interface 13 and the built-in megaphone 14, or switches on the circuit between the sound interface 13 and the external megaphone device 30, by using a connected controller 41. When an incoming call ring tone is output by the external megaphone device 30, the user will be ensured to receive every incoming call.

The present invention provides an external megaphone system of the mobile phone. The preferred embodiment described above discloses that the external megaphone device 30 is an extended fitting of the mobile phone 10, which is not intended to limit the present invention. The external megaphone device 30 described above can be used with the extended fittings of the conventional mobile phone 10, for example, the earphone with a microphone is one of the extended fittings of the mobile phone 10, and therefore the external megaphone device 30 is bound with the sound signal line of the earphone with a microphone to become an integral extended fitting of the mobile phone 10. Many other extended fittings of the mobile phone 10 may also be bound with the external megaphone device 30 of the present invention to become an integral extended fitting of the mobile phone.

Also, the present invention provides an external megaphone system of the mobile phone. When the external megaphone device 30 described above is connected to a mobile phone 10 with a function of playing MPEG Layer-3 (MP3) music, it may be used as an external megaphone device 30 of the mobile phone for playing MP3 music. That is, when the mobile phone 10 is put in the pocket or the handbag with the external megaphone device 30 exposed outside, the user can easily listen to the MP3 music being broadcast by the mobile phone through the external megaphone device 30.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An external megaphone system of the mobile phone for broadcasting the incoming call ring tone signal of the mobile phone, wherein the mobile phone has a body with a sound interface and a built-in megaphone provided within the body, the external megaphone system further comprising:
an external megaphone device; and
a sound output hole, provided on the body surface of the mobile phone for inserting the external megaphone device, thereby outputting the incoming call ring tone signal of the sound interface to the external megaphone device and the built-in megaphone.

2. The external megaphone system of the mobile phone according to claim 1, wherein the external megaphone system further comprises a switch provided at the sound output hole of the mobile phone, and the switch is connected to the sound interface, so that when the switch communicates the sound interface and connects to the external megaphone device, the incoming call ring tone signal of the sound interface is output thereby.

3. The external megaphone system of the mobile phone according to claim 2, wherein the switch is a mechanical switch or an electronic switch.

4. The external megaphone system of the mobile phone according to claim 1, wherein the external megaphone device comprises a megaphone and a sound signal line.

5. The external megaphone system of the mobile phone according to claim 4, wherein the external megaphone device is connected to the sound output hole of the mobile phone by the sound signal line.

6. The external megaphone system of the mobile phone according to claim 1, wherein the external megaphone device may be bound with an earphone line as an integral extended fitting of the mobile phone.

7. The external megaphone system of the mobile phone according to claim 1, wherein the mobile phone has a function of playing MPEG Layer-3 (MP3) music.

8. The external megaphone system of the mobile phone according to claim 1, wherein the external megaphone device is connected to the sound output hole of the mobile phone for playing the MP3 music of the mobile phone.

9. The external megaphone system of the mobile phone according to claim 3, wherein the electronic switch is connected to a controller.
